(19) United States
(12) Patent Application Publication
(10) Pub. No.: US 2004/0000479 A1
(43) Pub. Date: Jan. 1, 2004

(54) Gas sensor element

(76) Inventors: Toru Katafuchi, Kariya-shi (JP); Keigo Mizutani, Okazaki-shi (JP)

Correspondence Address: NIXON & VANDERHYE, PC, 1100 N GLEBE ROAD, 8TH FLOOR, ARLINGTON, VA, 22201-4714, US

(21) Appl. No.: 10/600,653

(22) Filed: Jun. 23, 2003

(30) Foreign Application Priority Data
Jun. 28, 2002 (JP) 2002-190387

(51) Int. Cl. G01N 27/26

(52) U.S. Cl. 204/424; 204/427; 204/426

(57) ABSTRACT

In a gas sensor element having a measurement gas chamber for introducing a measurement gas thereinto, a sensor cell, and an electrochemical cell, the sensor cell has an active electrode facing the measurement gas chamber, a first reference electrode forming a pair with the active electrode, and a solid-electrolyte plate having both the electrodes, and is so constructed that the concentration of a specific gas in the measurement gas chamber is detectable. The electrochemical cell has an inactive electrode facing the measurement gas chamber and being inactive to the specific gas, a second reference electrode forming a pair with the inactive electrode, and a solid-electrolyte plate having both the electrodes. The inactive electrode is formed of a metallic material containing at least one selected from Au, Ag, Cu and Pb and an additional metallic material Rh. This gas sensor element promises good measurement precision.

### BACKGROUND OF THE INVENTION

1. Field of the Invention

This invention relates to a gas sensor element installed in an exhaust system or the like of an internal-combustion engine to measure the concentration of NOx and so forth contained in exhaust gas.

2. Description of the Prior Art

As a gas sensor element used in gas sensors installed in exhaust systems of automobile engines to measure the concentration of a specific gas in exhaust gas, such as NOx concentration, HC concentration and CO concentration, an element is known which consists basically of a measurement gas chamber—for introducing thereinto a measurement gas from the outside, a sensor cell for detecting the concentration of specific gas present in the measurement gas chamber, and an electrochemical cell such as an oxygen monitor cell or an oxygen pumping cell (disclosed in, e.g., Japanese Patent Application Laid-open No. 10-227760, corresponding to EP 0 859 233 A2).

Here, the oxygen monitor cell detects oxygen concentration in the measurement gas chamber, and the oxygen pumping cell pumps oxygen into, or from, the measurement gas chamber.

Then, the above sensor cell has an active electrode facing the measurement gas chamber. This active electrode has the activity to decompose a specific gas. The sensor cell, in which the specific gas is decomposed at the active electrode, detects the concentration of the specific gas in accordance with an oxygen ionic current produced from this decomposition process.

An electrode facing the measurement gas chamber in the electrochemical cell is required to be an inert electrode insensitive to the specific gas.

Now, the use of the gas sensor element in the state it is exposed to high-temperature exhaust gas causes a change in quality of the electrode constituting the electrochemical cell. This change in quality causes a change in characteristics of the electrochemical cell, which may furthermore cause variations in measurement precision of the gas sensor element, i.e., running deterioration.

For example, where the electrode pertaining to the oxygen pumping cell has deteriorated, the performance of oxygen pumping in the measurement gas chamber may change, so that the concentration of oxygen remaining in the measurement gas chamber may change before and after the deterioration. In such a case, there is a possibility of causing variations in offset current, as shown in Example 2 described later, and consequently there is a possibility of the deterioration of detection precision in the sensor cell.

In some cases, an oxygen monitor cell is also provided in the measurement gas chamber in order to control the oxygen pumping cell. Also where the electrode pertaining to this oxygen monitor cell has deteriorated, the performance of the oxygen pumping cell may change like the above case, and there is a possibility of the deterioration of detection precision in the sensor cell.

### SUMMARY OF THE INVENTION

The present invention was made taking account of such problems the prior art has had. Accordingly, an object of the present invention is to provide a gas sensor element which can not easily cause any running deterioration in measurement precision.

To achieve the above object, the present invention provides a gas sensor element comprising a measurement gas chamber for introducing thereinto a measurement gas from the outside, a sensor cell, and an electrochemical cell;

the sensor cell comprising an active electrode facing the measurement gas chamber, a first reference electrode forming a pair with the active electrode, and a solid-electrolyte plate having both the electrodes, and being so constructed that the concentration of a specific gas in the measurement gas chamber is detectable; and

the electrochemical cell comprising an inactive electrode facing the measurement gas chamber and being inactive to the specific gas, a second reference electrode forming a pair with the inactive electrode, and a solid-electrolyte plate having both the electrodes;

the inactive electrode comprising a metallic material containing at least one selected from Au, Ag, Cu and Pb and an additional metallic material Rh.

In the gas sensor element according to the present invention, the electrochemical cell has an inactive electrode facing the measurement gas chamber, and the inactive electrode comprises the metallic material and the additional metallic material Rh.

Any conventional inactive electrodes containing no Rh undergo deterioration with time when exposed to measurement gas. When used for a long time, the inactive electrode aggregates gradually, so that the characteristics of the electrochemical cell may vary with time to cause running deterioration in measurement precision. This is because the inactive electrode contains a low-melting point material such as Au, Ag, Cu or Pb so as to be low active to the specific gas.

In the present invention, the Rh, which has a high melting point and superior heat resistance, is added to the metallic material so that the inactive electrode can have a high heat resistance to thereby keep the electrode from aggregating. Thus, a gas sensor element can be obtained which can not easily cause the deterioration in measurement precision over a long period of time and has superior running performance (durability).

### BRIEF DESCRIPTION OF THE DRAWINGS

FIG. 1 is a cross-sectional illustration of a gas sensor element in Example 1.

FIG. 2 is a transverse sectional illustration (a section as viewed from arrows A-A in FIG. 1) of the gas sensor element in Example 1.

FIG. 3 is a graph showing the relationship between NO concentration and output at the initial stage and 40,000 km running of a gas sensor element according to the present invention in Example 2.

FIG. 4 is a graph showing the relationship between the NO concentration and the output at the initial stage and 40,000 km running of a gas sensor element according to a comparative sample in Example 2.

FIG. 5 is a graph showing the relationship between running distance and sensor cell current of gas sensor elements according to the present invention and comparative sample in Example 2 (but measured in an atmosphere not containing any NO).

FIG. 6 is a cross-sectional illustration of a gas sensor element in Example 3, which is so constructed that measurement gas chambers are arranged in stack direction.

FIG. 7 is a cross-sectional illustration of a gas sensor element in Example 3, which is so constructed that measurement gas chambers are arranged in stack direction, but is different from that shown in FIG. 6.

FIG. 8 is a cross-sectional illustration of a gas sensor element in Example 4, which is so constructed that an oxygen monitor cell and a sensor cell are arranged in series.

FIG. 9 is a cross-sectional illustration of a gas sensor element in Example 5, which is of a double-cell type consisting of a sensor cell and an oxygen pumping cell.

### DESCRIPTION OF THE PREFERRED EMBODIMENTS

The gas sensor element according to the present invention consists basically of a measurement gas chamber for introducing thereinto a measurement gas from the outside, a sensor cell, and an electrochemical cell.

The sensor cell has an active electrode facing the measurement gas chamber, a first reference electrode forming a pair with the active electrode, and a solid-electrolyte plate holding both the electrodes, and being so constructed that the concentration of a specific gas in the measurement gas chamber is detectable. The electrochemical cell also has an inactive electrode facing the measurement gas chamber and being inactive to the specific gas, a second reference electrode forming a pair with the inactive electrode, and a solid-electrolyte plate holding both the electrodes.

In the above gas sensor element, the inactive electrode is formed of a metallic material containing at least one selected from Au, Ag, Cu and Pb and also an additional metallic material Rh. These are contained together with other electrode material of various types. As such other electrode material, Pt may be used as a further component of the above metallic material.

In the gas sensor element according to the present invention, the active electrode of the sensor cell may chiefly composed of at least one selected from Pt, Rh, Pd, Ir and Ru.

The gas sensor element according to the present invention can measure NOx concentration, HC concentration and CO concentration in the measurement gas.

In the above inactive electrode, the additional metallic material Rh may preferably be added in an amount of from 0.01 to 3.0% by weight as outer percentage, based on 100% by weight of the above metallic material. In such a case, the inactive electrode can be more improved in heat resistance, and this can more keep the electrode from aggregating and enables achievement of the gas sensor element which can not easily cause the deterioration in measurement precision over a long period of time and has superior running performance (durability).

If the Rh is added in an amount of less than 0.01% by weight as outer percentage, its addition may be in too small quantity to obtain the effect of preventing the inactive electrode from aggregating. If on the other hand it is added in an amount of more than 3.0% by weight as outer percentage, the inactive electrode may come active because the Rh has an activity to the specific gas.

The electrochemical cell may be an oxygen pumping cell which is so constructed as to pump oxygen into, or from, the measurement gas chamber. The electrochemical cell may also be an oxygen monitor cell which is so constructed that the concentration of oxygen in the measurement gas chamber is detectable.

The electrochemical cell may also be provided in plurality.

The gas sensor element according to the present invention may be, as mentioned above, so constructed that the concentration of NOx in measurement gas is detectable. In this case, NOx is decomposed at the active electrode of the sensor cell and an oxygen ionic current thus produced is utilized to know the concentration of NOx. Here, there may be no distinction between the oxygen ions produced as a result of the decomposition of NOx and the oxygen ions originally present in the measurement gas chamber. Accordingly, it is preferable to pump the oxygen into, or from, the measurement gas chamber to keep the oxygen concentration in the chamber at a constant value.

It is also preferable to provided the oxygen monitor cell for detecting the oxygen concentration in the measurement gas chamber. Inasmuch as the inactive electrode is provided, the oxygen concentration in the measurement gas chamber can be detected and any effect of oxygen on the sensor cell can be cancelled.

The oxygen pumping cell and the oxygen monitor cell may also each provided in plurality.

A cell for measuring the concentration of oxygen in measurement gas may also be provided as the electrochemical cell, and a composite sensor element may be made up which can detect the concentration of two or more kinds of gases by the use of one element.

In addition, in the case of a gas sensor element used as one installed in the exhaust system of an internal-combustion engine, it may be constructed as an element provided with an air-fuel ratio cell with which the air-fuel ratio in a combustion chamber of the internal-combustion engine can be detected from the oxygen concentration in measurement gas.

The present invention is described below in greater detail by giving Examples and with reference to the accompanying drawings.

### EXAMPLE 1

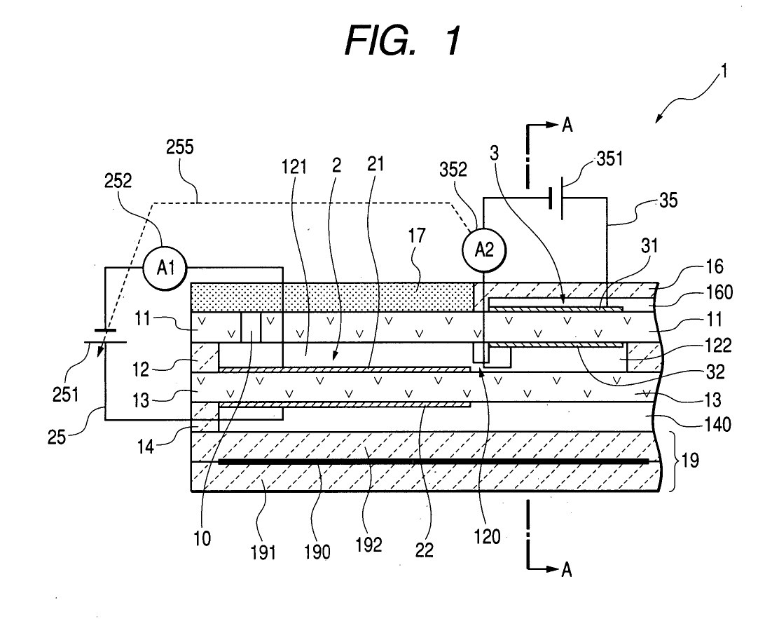

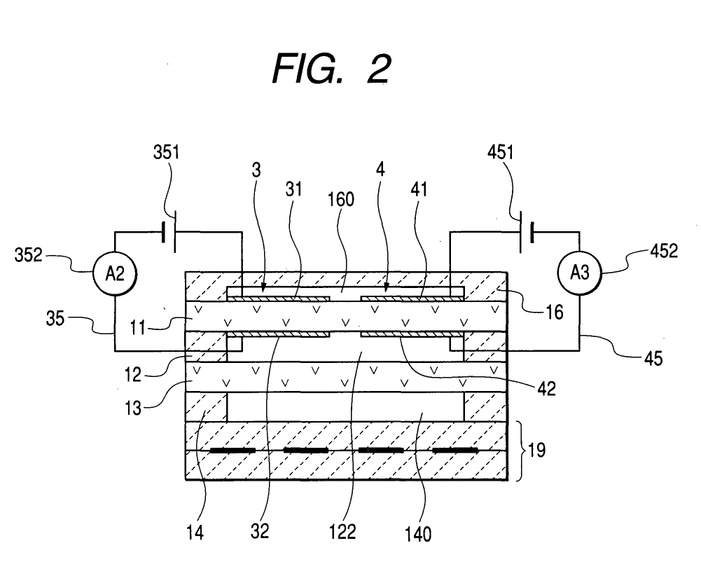

In this Example, as shown in FIGS. 1 and 2, the gas sensor element consists basically of first and second measurement gas chambers 121 and 122 which constitute the measurement gas chamber for introducing thereinto a measurement gas from the outside, a sensor cell 4, and as electrochemical cells an oxygen pumping cell 2 and an oxygen monitor cell 3.

As shown in FIG. 2, the sensor cell 4 is constituted of an active electrode 42 facing the second measurement gas chamber 122, a first reference electrode 41 forming a pair with the active electrode 42, and a fist solid-electrolyte plate 11 holding both the electrodes 41 and 42, and is so constructed that the concentration of a specific gas in the second measurement gas chamber 122 is detectable.

The electrochemical cell oxygen pumping cell 2 is constituted of an inactive electrode 21 facing the first measurement gas chamber 121 and is inactive to the specific gas, a second reference electrode 22 forming a pair with the inactive electrode 21, and a second solid-electrolyte plate 13 holding both the electrodes 21 and 22. The inactive electrode 21 is formed of a metallic material containing at least Au, and the additional metallic material Rh.

The electrochemical cell oxygen monitor cell 3 is constituted of an inactive electrode 32 facing the second measurement gas chamber 122 and is inactive to the specific gas, a second reference electrode 31 forming a pair with the inactive electrode 32, and a first solid-electrolyte plate 11 holding both the electrodes 31 and 32. The inactive electrode 32 is formed of a metallic material containing at least Au, and the additional metallic material Rh.

This Example is detailed below.

The gas sensor element 1 of this Example is used as one installed in the exhaust system of an automobile engine to measure the NOx concentration in automobile exhaust gas.

As shown in FIGS. 1 and 2, the gas sensor element 1 of this Example has the first and second measurement gas chambers 121 and 122, which are formed between the first and second solid-electrolyte plates 11 and 13 stacked via a spacer 12 for the first and second measurement gas chambers 121 and 122; a first reference gas chamber 140 into which the air serving as reference gas is to be introduced, formed between the second solid-electrolyte plate 13 and a ceramic heater 19 via a spacer 14 for the first reference gas chamber 140; a second reference gas chamber 160 formed between the first solid-electrolyte plate 11 and a space-forming member 16; the oxygen pumping cell 2, which pumps oxygen into, or from, the first measurement gas chamber 121; the oxygen monitor cell 3, which monitors the concentration of oxygen in the second measurement gas chamber 122; and the sensor cell 4, which detects the concentration of NOx in the second measurement gas chamber 122.

As described above, the first and second measurement gas chambers 121 and 122 are defined by the space formed by the first and second solid-electrolyte plates 11 and 13 and the spacer 12. The first measurement gas chamber 121 communicates with the outside through an inlet hole 10 provided in the first solid-electrolyte plate 11, and the first measurement gas chamber 121 communicates with the second measurement gas chamber 122 through a diffusion path 120.

The gas sensor element of this Example also has a porous diffusion layer 17 provided on the first solid-electrolyte plate 11 and covering its inlet hole 10, and has the space-forming member 16 adjacently to the porous diffusion layer 17 to form the second reference gas chamber 160.

The ceramic heater 19 is constituted of a heater substrate 191, a heating element 190 provided on the heater substrate 191, and a cover plate 192 which covers the heating element 190.

Then, the first and second solid-electrolyte plates 11 and 13 are made of zirconia (ZnO₂), and the other members spacer 12, spacer 14, space-forming member 16, porous diffusion layer 17, heater substrate 191 and cover plate 192 are made of alumina (Al₂O₃).

The oxygen pumping cell 2 is constituted of the inactive electrode 21 facing the first measurement gas chamber 121 provided between the first and second solid-electrolyte plates 11 and 13, and the second reference electrode 22 facing the first reference gas chamber 140 provided between the first solid-electrolyte plate 13 and the ceramic heater 19. Both the electrodes 21 and 22 are connected to a pumping circuit 25 having a power source 251 and an ammeter 252.

The oxygen monitor cell 3 is constituted of the inactive electrode 32 facing the second measurement gas chamber 122 communicating with the first measurement gas chamber 121, provided between the first and second solid-electrolyte plates 11 and 13, and the second reference electrode 31 facing the second reference gas chamber 160 provided between the first solid-electrolyte plate 11 and the space-forming member 16. Both the electrodes 31 and 32 are connected to a monitoring circuit 35 having a power source 351 and an ammeter 352.

The sensor cell 4 is constituted of the active electrode 42 facing the second measurement gas chamber 122 communicating with the first measurement gas chamber 121, provided between the first and second solid-electrolyte plates 11 and 13, and the first reference electrode 41 facing the second reference gas chamber 160 provided between the first solid-electrolyte plate 11 and the space-forming member 16. Both the electrodes 41 and 42 are connected to a sensor circuit 45 having a power source 451 and an ammeter 452.

In order to control the action of the oxygen pumping cell 2 by the aid of the oxygen monitor cell 3, a feed back circuit 255 is further provided which extends toward the power source 251 of the pumping circuit 25 from the ammeter 352.

Then, the inactive electrodes 21 and 32 are each formed of a metallic material containing Au and Pt, and the additional metallic material Rh. Here, the Au is contained in an amount of 3% by weight (inner % by weight) based on 100% by weight of the metallic material containing Au and Pt. Also, the Rh is also added in an amount of 0.5% by weight as outer percentage, based on 100% by weight of the metallic material containing Au and Pt.

The active electrode 42 is formed of an electrode material containing Pt and Rh. The other second reference electrodes 22 and 31 and first reference electrode 41 are each also formed of an electrode material containing Pt and Rh, like the active electrode 42. Here, the Rh is contained in an amount of 20% by weight (inner % by weight) based on 100% by weight of the electrode material containing these Pt and Rh.

The above respective electrodes may be formed by any conventionally known method, e.g., by preparing corresponding electrode material pastes, and printing the electrode material pastes on the corresponding solid-electrolyte plates, followed by firing (sintering).

The inactive electrodes 21 and 32 are, as described above, each formed of the metallic material and the additional metallic material Rh. Since the inactive electrodes 21 and 32 contains the additional metallic material Rh, having a high melting point and a superior heat resistance, and the Rh improves the heat resistance of the inactive electrodes 21 and 32, the inactive electrodes 21 and 32 can be made hard to undergo deterioration with time even when exposed to the measurement gas composed of hot exhaust gas.

Thus, according to this Example, the gas sensor element can be obtained which can not easily cause the deterioration in measurement precision over a long period of time and has superior running performance (durability).

### EXAMPLE 2

In this Example, the gas sensor element of the present invention and a gas sensor element according to Comparative Sample are prepared to compare the performance of the both each other.

First, the gas sensor element described in Example 1 is prepared as the gas sensor element of the present invention. As the gas sensor element according to Comparative Sample, a gas sensor element is prepared which is the same element as that of Example 1 except that any Rh is not added to the inactive electrodes of the oxygen pumping cell and oxygen monitor cell.

Then, the respective gas sensor elements were fitted to gas sensors, and were exposed to a measurement gas composed of oxygen (20%), nitrogen and NO to measure NO concentration actually. Here, as the measurement gas, four kinds of gases having different NO concentrations were prepared.

The measurement of NO concentrations by the use of these gas sensor elements were also made at the initial stage and after 40,000 km running. The measurement at the initial stage is meant to be measurement made immediately after the gas sensor elements have been manufactured. The measurement after 40,000 km running is meant to be measurement made in the following way: Each gas sensor element is fitted to the exhaust system of an actual automobile engine, in the state of which the automobile is driven by 40,000 km. After the gas sensor element has sufficiently been exposed to the exhaust gas of the automobile, it is taken out to make measurement.

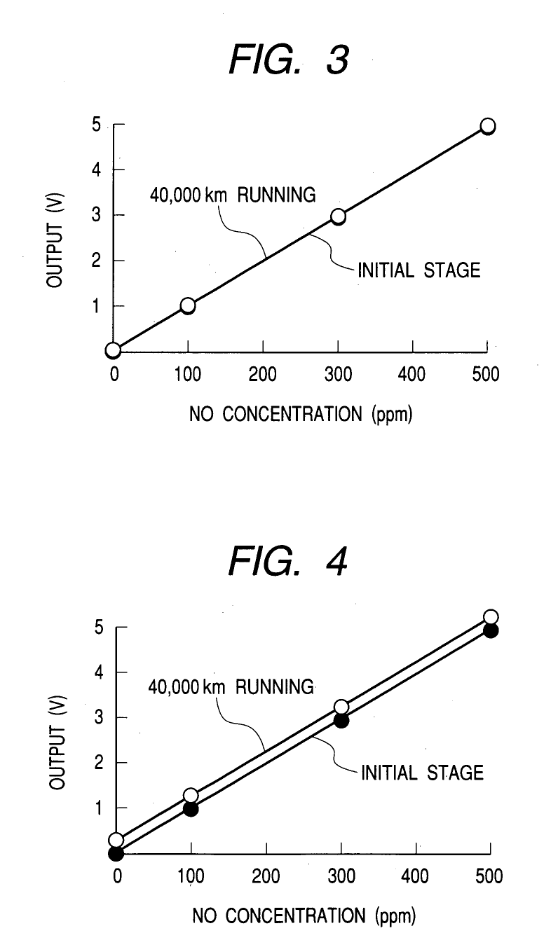

The results of these are shown in FIG. 3 (the present invention) and FIG. 4 (no Rh added to the inactive electrodes).

As can be seen from FIG. 3, the output (the output of the sensor cell, and is the value of the ammeter 452 shown in FIG. 2) of the gas sensor element according to the present invention is substantially the same between that at the initial stage and that after 40,000 km running. That is, any running deterioration has not take place. However, as can be seen from FIG. 4, the gas sensor element of Comparative Sample, containing no Rh in the inactive electrodes, shows differences in the output between that at the initial stage and that after 40,000 km running.

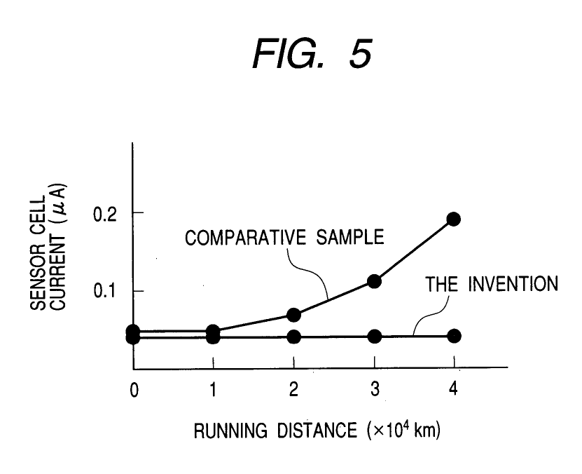

On the above gas sensor element of the present invention and the above gas sensor element according to Comparative Sample, electric currents flowing through the sensor cells of the respective gas sensor elements in a case in which the running distance was made gradually longer were also measured in the state the NO concentration was 0 (zero). The results are shown in FIG. 5.

As can be seen from FIG. 5, in the gas sensor element of the present invention, the sensor cell current is at a constant value without regard to the running distance. In the gas sensor element of Comparative Sample, the sensor cell current increases with an increase in the running distance. Since this measurement is made in the atmosphere where the NO concentration is 0, this electric current is what is called the offset current.

The electric current flowing through the sensor cell of a gas sensor element comes to the value found when the oxygen ionic current attributable to the oxygen produced by decomposing NOx is added to this offset current. Hence, when the offset current changes with time, only inaccurate values may become obtainable from immediately after the gas sensor element has been manufactured, although the concentration can accurately be measured immediately after it has begun to be used.

Thus, in the gas sensor element according to the present invention, since the offset current little changes without regard to the running distance, the gas concentration can accurately be measured even when used over a longer running distance.

### EXAMPLE 3

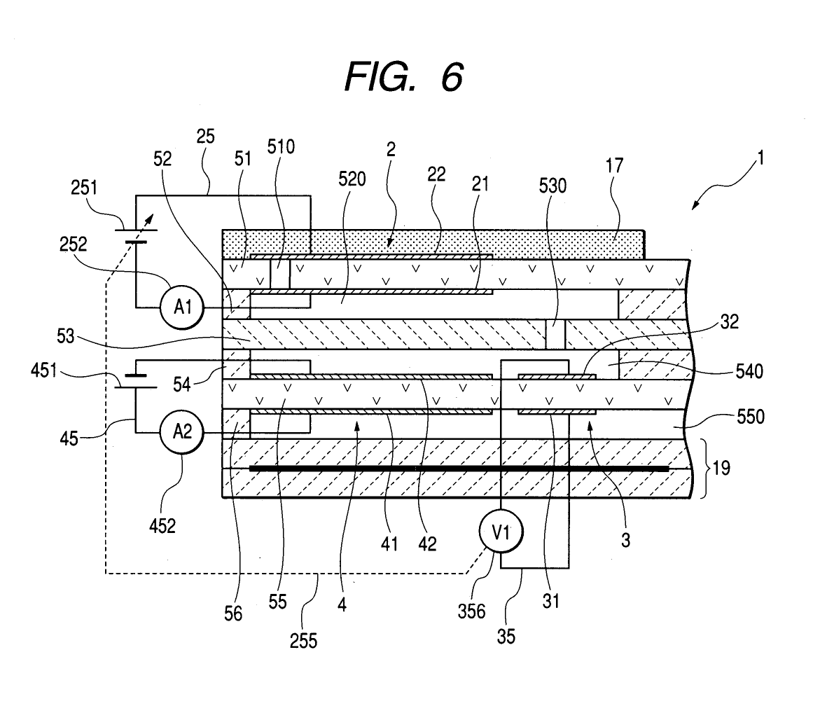

In this Example, as shown in FIG. 6, a gas sensor element 1 is so constructed that first and second measurement gas chambers 520 and 540 are positioned in the direction where first and second solid-electrolyte plates 51 and 55 and so forth are stacked. Like Example 1, this gas sensor element 1 has a sensor cell 4, an oxygen pumping cell 2 and an oxygen monitor cell 3.

The gas sensor element 1 of this Example is made up by placing in a stack a first solid-electrolyte plate 51, a spacer 52, a horizontal partition plate 53, a spacer 54, a second solid-electrolyte plate 55, a spacer 56 and a ceramic heater 19 in this order from the top.

The first measurement gas chamber 520 is defined by the first solid-electrolyte plate 51, the horizontal partition plate 53 and the spacer 52. The second measurement gas chamber 540 is defined by the horizontal partition plate 53, the second solid-electrolyte plate 55 and the spacer 54. A reference gas chamber 550 is defined by the second solid-electrolyte plate 55, the spacer 56 and the ceramic heater 19.

The measurement gas is introduced into the first measurement gas chamber 520 through an inlet hole 510 provided in the first solid-electrolyte plate 51. A porous diffusion layer 17 is so stacked on the first solid-electrolyte plate 51 as to cover the latter's inlet hole 510. The first measurement gas chamber 520 communicates with the second measurement gas chamber 542 through a diffusion path 530.

Then, an inactive electrode 21 of the oxygen pumping cell 2 faces the first measurement gas chamber 520, and a second reference electrode 22 is exposed to the outside atmosphere of the gas sensor element through the porous diffusion layer (diffusion resistance layer) 17. The inactive electrode 21 and the second reference electrode 22 form a pair with each other and are provided on the first solid-electrolyte plate 51.

An active electrode 42 facing the second measurement gas chamber 540 of the sensor cell 4 and a first reference electrode 41 facing the reference gas chamber 550 form a pair with each other and are provided on the second solid-electrolyte plate 55. An inactive electrode 32 of the oxygen monitor cell 3 and a second reference electrode 31 facing the reference gas chamber 550 form a pair with each other and are provided on the second solid-electrolyte plate 55.

Then, the inactive electrode 21 and second reference electrode 22 of the oxygen pumping cell 2 are connected to a pumping circuit 25 having a power source 251 and an ammeter 252. The second reference electrode 31 and inactive electrode 32 of the oxygen monitor cell 3 are connected to a monitor circuit 35 having a voltmeter 356. The electrodes 41 and 42 of the sensor cell 4 are connected to a sensor circuit 45 having a power source 451 and an ammeter 452.

In order to control the action of the oxygen pumping cell 2 by the aid of the oxygen monitor cell 3, a feed back circuit 255 is further provided which extends toward the power source 251 of the pumping circuit 25 from the voltmeter 356.

Then, the inactive electrodes 21 and 32 are formed in the same manner as those in Example 1, and are each formed of the metallic material containing Au and. Pt, and the additional metallic material Rh.

The active electrode 42 is also formed in the same manner as that in Example 1, and is formed of the electrode material containing Pt and Rh. The other second reference electrodes 22 and 31 and first reference electrode 41 are also formed in the same manner as those in Example 1, and are each formed of the electrode material containing Pt and Rh, like the active electrode 42.

Others are constructed in the same manner as in Example 1, and the gas sensor element of this Example also has the same effect as that in Example 1.

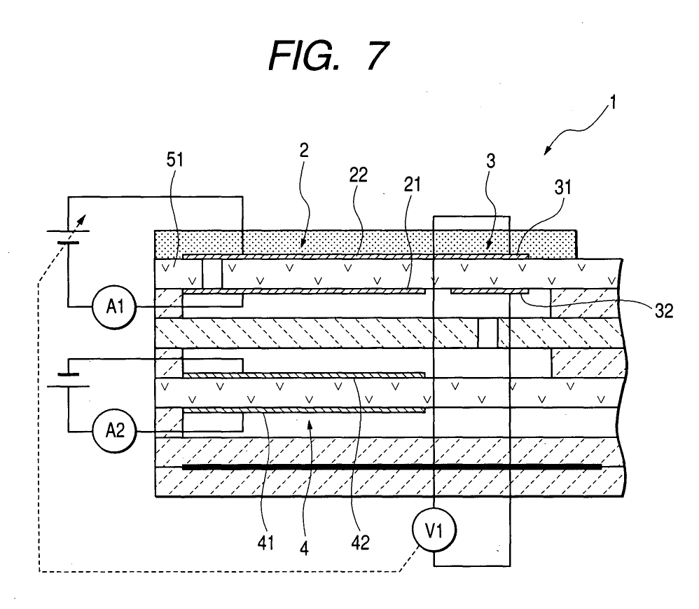

Incidentally, as shown in FIG. 7, the oxygen monitor cell 3 may be provided at the first solid-electrolyte plate 51. The second reference electrode 22 of the oxygen pumping cell 2 and the second reference electrode 31 of the oxygen monitor cell 3 may also be integrated.

### EXAMPLE 4

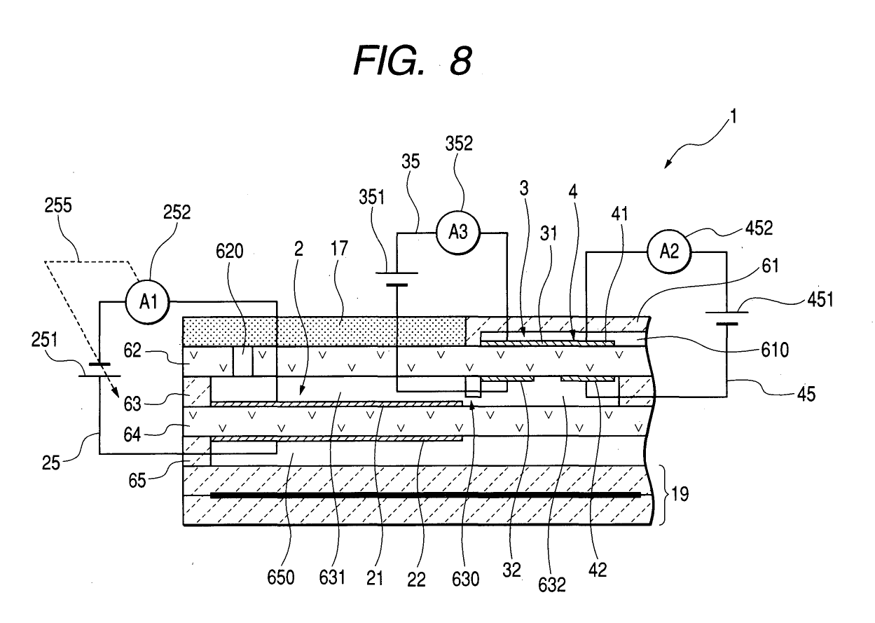

In this Example, as shown in FIG. 8, a gas sensor element 1 is so constructed that a ensor cell 4 and an oxygen monitor cell 3 are connected in series. Like Example 1, this gas sensor element 1 also has a sensor cell 4, and has first and second measurement gas chambers 631 and 632.

The gas sensor element 1 of this Example is made up by placing in a stack a space-forming member 61, a first solid-electrolyte plate 62, a spacer 63, a second solid-electrolyte plate 64, a spacer 65 and a ceramic heater 19 in this order from the top.

A first reference gas chamber 610 is defined by the space-forming member 61 and the first solid-electrolyte plate 62. The first and second measurement gas chambers 631 and 632 are defined by the first solid-electrolyte plate 62, the spacer 63 and the second solid-electrolyte plate 64. A second reference electrode 650 is defined by the second solid-electrolyte plate 64, the spacer 65 and the ceramic heater 19.

The measurement gas is introduced into the first measurement gas chamber 62 through an inlet hole 620 provided in the first solid-electrolyte plate 62. A porous diffusion layer 17 is so stacked on the first solid-electrolyte plate 62 as to cover the latter's inlet hole 620. The first measurement gas chamber 631 communicates with the second measurement gas chamber 632 through a diffusion path 630.

Then, an inactive electrode 21 of the oxygen pumping cell 2 faces the first measurement gas chamber 631, and a second reference electrode 22 faces the second measurement gas chamber 650. The inactive electrode 21 and the second reference electrode 22 form a pair with each other and are provided on the second solid-electrolyte plate 64.

An active electrode 42 facing the second measurement gas chamber 632 of the sensor cell 4 and a first reference electrode 41 facing the first reference gas chamber 610 form a pair with each other and are provided on the first solid-electrolyte plate 62. An inactive electrode 32 of the oxygen monitor cell 3 and a second reference electrode 31 facing the first reference gas chamber 610 form a pair with each other and are provided on the first solid-electrolyte plate 62. The electrodes 41 and 31 are integrated.

Then, the inactive electrode 21 and second reference electrode 22 of the oxygen pumping cell 2 are connected to a pumping circuit 25 having a power source 251 and an ammeter 252. The electrodes 31 and 32 of the oxygen monitor cell 3 are connected to a monitor circuit 35 having a power source 351 and an ammeter 352. The electrodes 41 and 42 of the sensor cell 4 are connected to a sensor circuit 45 having a power source 451 and an ammeter 452.

In order to control the action of the oxygen pumping cell 2 by the aid of the oxygen monitor cell 3, a feed back circuit 255 is further provided which extends toward the power source 251 of the pumping circuit 25 from the ammeter 252.

Then, the inactive electrodes 21 and 32 are formed in the same manner as those in Example 1, and are each formed of the metallic material containing Au and Pt, and the additional metallic material Rh.

The active electrode 42 is also formed in the same manner as that in Example 1, and is formed of the electrode material containing Pt and Rh. The other second reference electrodes 22 and 31 and first reference electrode 41 are also formed in the same manner as those in Example 1, and are each formed of the electrode material containing Pt and Rh, like the active electrode 42.

Others are constructed in the same manner as in Example 1, and the gas sensor element of this Example also has the same effect as that in Example 1.

Besides the construction shown in FIG. 8, the gas sensor element may be so constructed that the oxygen pumping cell 2 is provided at the first solid-electrolyte plate 62 and the sensor cell 4 and oxygen monitor cell 3 are provided at the second solid-electrolyte plate 64.

### EXAMPLE 5

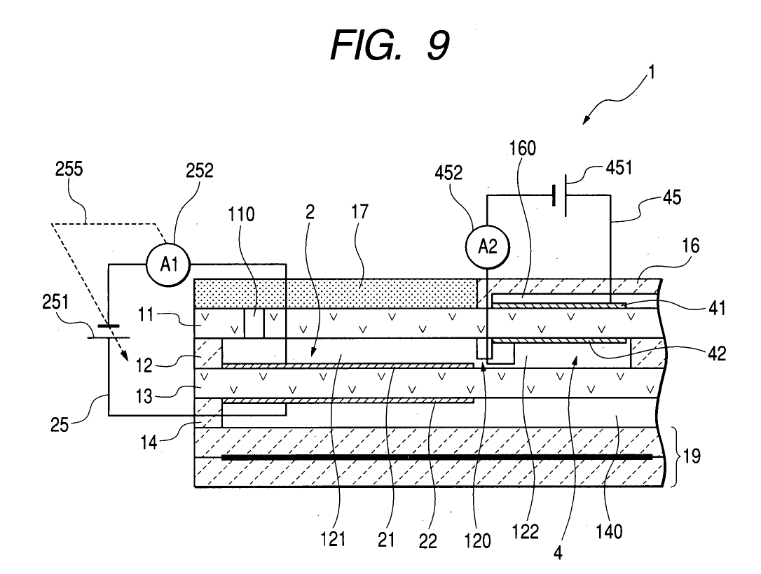

This Example is, as shown in FIG. 9, a gas sensor element having the same construction as that of Example 1 except that it is a double-cell element having no oxygen monitor cell.

Then, the oxygen pumping cell 2 is provided with a feed back circuit 255 which extends toward a power source 251 from the ammeter 252 provided in a pumping circuit 25.

Others are constructed in the same manner as in Example 1, and the gas sensor element of this Example also has the same effect as that in Example 1.

Besides the construction shown in FIG. 9, the gas sensor element may be so constructed that the oxygen pumping cell 2 is provided at the first solid-electrolyte plate 11 and the sensor cell 4 is provided at the second solid-electrolyte plate 13.

### EXAMPLES 6 TO 9

These Examples 6, 7, 8 and 9 are gas sensor elements having the same construction as that of Examples 1, 3, 4 and 5, respectively, except that the inactive electrodes 21 and 32 are each formed of a metallic material containing Ag and Pt, and the additional metallic material Rh. The gas sensor elements of these Examples also-have substantially the same effect as that in Examples 1, 3, 4 and 5.

### EXAMPLES 10 TO 13

These Examples 10, 11, 12 and 13 are gas sensor elements having the same construction as that of Examples 1, 3, 4 and 5, respectively, except that the inactive electrodes 21 and 32 are each formed of a metallic material containing Cu and Pt, and the additional metallic material Rh. The gas sensor elements of these Examples also have substantially the same effect as that in Examples 1, 3, 4 and 5.

### EXAMPLES 14 TO 17

These Examples 14, 15, 16 and 17 are gas sensor elements having the same construction as that of Examples 1, 3, 4 and 5, respectively, except that the inactive electrodes 21 and 32 are each formed of a metallic material containing Pb and Pt, and the additional metallic material Rh. The gas sensor elements of these Examples also have substantially the same effect as that in Examples 1, 3, 4 and 5.

What is claimed is:

1. A gas sensor element comprising a measurement gas chamber for introducing thereinto a measurement gas from the outside, a sensor cell, and an electrochemical cell;
said sensor cell comprising an active electrode facing said measurement gas chamber, a first reference electrode forming a pair with the active electrode, and a solid-electrolyte plate having both the electrodes, and being so constructed that the concentration of a specific gas in said measurement gas chamber is detectable; and
said electrochemical cell comprising an inactive electrode facing said measurement gas chamber and being inactive to the specific gas, a second reference electrode forming a pair with the inactive electrode, and a solid-electrolyte plate having both the electrodes;
said inactive electrode comprising a metallic material containing at least one selected from Au, Ag, Cu and Pb and an additional metallic material Rh.

2. The gas sensor element according to claim 1, wherein said additional metallic material Rh is added in an amount of from 0.01 to 3.0% by weight as outer percentage, based on 100% by weight of the metallic material.

3. The gas sensor element according to claim 1, wherein said electrochemical cell is an oxygen pumping cell which is so constructed as to pump oxygen into, or from, said measurement gas chamber.

4. The gas sensor element according to claim 1, wherein said electrochemical cell is an oxygen monitor cell which is so constructed that the concentration of oxygen in said measurement gas chamber is detectable.

5. The gas sensor element according to claim 1, wherein said metallic material of the inactive electrode further contains Pt.

6. The gas sensor element according to claim 1, wherein said metallic material contains Au.

7. The gas sensor element according to claim 1, wherein said metallic material contains Ag.

8. The gas sensor element according to claim 1, wherein said metallic material contains Cu.

9. The gas sensor element according to claim 1, wherein said metallic material contains Pb.

10. The gas sensor element according to claim 5, wherein said metallic material contains Au.

11. The gas sensor element according to claim 5, wherein said metallic material contains Ag.

12. The gas sensor element according to claim 5, wherein said metallic material contains Cu.

13. The gas sensor element according to claim 5, wherein said metallic material contains Pb.
